(19) United States
(12) Patent Application Publication
(10) Pub. No.: US 2012/0184277 A1
(43) Pub. Date: Jul. 19, 2012

(54) METHOD FOR SELECTING COMMUNICATIONS NETWORK UTILIZING QUALITY OF SERVICE MEASUREMENTS

(75) Inventors: Jouni Hiltunen, Oulu (FI); Jarmo Prokkola, Oulu (FI); Pekka Ruuska, Oulu (FI); Martin Varela, Oulu (FI)

(73) Assignee: VALTION TEKNILLINEN TUTKIMUSKESKUS, VTT (FI)

(21) Appl. No.: 13/395,555

(22) PCT Filed: Sep. 15, 2010
(86) PCT No.: PCT/FI10/50707

§ 371 Date: Apr. 5, 2012

(30) Foreign Application Priority Data
Sep. 18, 2009 (FI) 20095966

(51) Int. Cl. H04W 36/14

(52) U.S. Cl. 455/437

(57) ABSTRACT

The invention relates to a method for determining a level of QoS of at least two concurrent communications networks and for executing a vertical handover if a predetermined QoS level is not fulfilled in the serving communications network. The invention also relates to a mobile terminal utilizing the method. The invention relates to also a home agent residing in a serving network and a computer program product utilized in a mobile terminal for accomplishing the method steps.

### TECHNICAL FIELD

The invention relates to a method for determining and selecting a proper communications network from a plurality of different kind of communications networks by utilizing real-time quality of service measurements. The invention also relates to mobile terminal utilizing the method and a home agent residing in a core network of the serving communications network. The invention relates also to a computer program product utilized in the mobile client for performing a vertical handover from one communications network to another communications network.

### BACKGROUND

A modern wireless information terminal, such as a laptop computer, smart phone, PDA (Personal Digital Assistant) or video game console for example, may comprise means for accessing different kinds of wired or wireless communications networks. Some examples of possible local communications networks are LAN (Local Area Network), Wi-Fi®, GSM (Global System for Mobile communications), GPRS (General packet radio service), 3G (3^{rd} Generation) and WiMAX (Worldwide Interoperability for Microwave Access). If the wireless terminal is moving, then most probably at some time a handover from one serving base station to another base station is needed. However, inside one particular communications network there are proper procedures how the handover should be accomplished smoothly so that the user does not discern the handover and the quality of service is guaranteed to the user at all times.

If there are several alternative communications networks, mobility management is more complicated. Generally, there are different kinds of criterions for selecting the serving communications network from a group of possible communications networks. One alternative is to use the communications network that was used last. Another alternative is to select a communications network that has the strongest field strength at that moment. A third alternative is to select a communications network that can offer the broadest bandwidth at that time.

Vertical handovers, which are accomplished between different communications networks utilizing different network technologies, need a high-level support mechanism. Some examples of utilized support mechanisms are MIP (Mobile IP), HIP (Host Identity Protocol) or mSCTP (mobile Stream Control Transmission Protocol). Because all these protocols are logically above the network level they cannot utilize available link layer or network layer knowledge. Therefore, there exists a decision making problem: How the wireless system or terminal knows when a vertical handover to another communications network is needed and also possible.

The prior art mobility management protocols give priority to field strength measurements or a possibility to offer a broadband communications network to the end-user. This means Wi-Fi® if it is available or Ethernet if it is connected. In some cases this may not be advantageous to the user. A network offering strong field strength can in the same time be congested, slow, noisy and cause a lot of transmission errors. The prior art mobility management systems do not take into account the quality that the end-user sees and which can change very rapidly.

The quality of service can change very rapidly especially in communications networks where random selection is utilized as in Wi-Fi® and Ethernet. In those networks the quality of service is based more on the load of the network than on the nominal speed or measured field strength of the network.

The end-users are not able to optimize their network uses because although there are available a lot of different kinds of networks, the knowledge of their communication capability is poor. And unfortunately the service capacity and capability of the networks is hard to find out. It is common that the end-user can measure the speed of his or her own communications connection back and forth from own terminal device to a server of the service provider. However, this does not tell to the end-user how well the available connections suit the needs and used applications of the end-user at that moment. The measurement can tell only a momentary ability of the available communications networks.

Some proposals for enhancing above-mentioned problems of the end-user position have been depicted.

In smart phones there is a possibility to change from a cellular system to Wi-Fi®. However, if a cellular service provider exists, it is always preferred. The end-user may make a vertical handover from the cellular system to Wi-Fi by his or her own command.

IEEE 802.21 standard supports a change-over between different kinds of wireless networks. However, not all wireless networks are supported in the standard.

In 3G networks there is defined a change-over between 3G and Wi-Fi® networks. A change-over to other possible network technologies is not possible. In addition the Wi-Fi® network must belong to the same service provider as the 3G network.

Prior art USB modems support change-over between 3G and GPRS networks but not a change-over to some other communications network, for example WiMAX.

Laptops comprise commonly Wi-Fi® properties and they can also be connected to a wired Ethernet network. When utilizing Wi-Fi® the laptop chooses the last used network if signal strength is sufficient. The other wireless networks can be seen as an alternative but they are not selected automatically. If a need for changing the network arises the user must do the change-over by him or herself.

From US 20060030319 is known a method where a network stability coefficient of each access network is determined based on both the current status information of each access network obtained by a network status collector and the user configuration information provided by a user profile of the mobile device. An access network selector selects an access network with maximum network stability coefficient, to establish a connection. However, new real-time quality metrics are not provided after the made network selection.

A book of Farhan Siddiqui “Mobility management techniques for heterogeneous wireless networks”, ISBN: 978-0-549-29158-9, depicts, how to enable seamless mobility in heterogeneous access environments. In Farhan a handover management solution for achieving smooth mobility across different access technologies such as cellular (UMTS, GPRS), Wireless LANs, etc. is suggested. In the depicted solution, Quality of Service (QoS) is measured on real-time bases and it is depicted as a network selection criterion. The QoS level is measured utilizing 5×20 seconds ping transmissions to all possible gateway nodes of different available communications networks whereto the terminal can make a vertical handover. However, this kind of measurement system does not give application specific QoS data.

Therefore, there is a need for a solution where QoS data is available on real-time bases to the application of the end-user, which can help the end-user to decide and make a vertical handover.

### SUMMARY OF SOME EXAMPLES OF THE INVENTION

An aspect of the invention is to provide a method for executing a vertical handover, the method comprising:
measuring at least one parameter of a quality of service (QoS) of a serving communications network in a mobile apparatus during a connection;
determining if the measured quality of service parameter is above a threshold;
determining if a quality of service level of at least one concurrent communications network is needed,
measuring in real-time simultaneously both a quality of service level of the serving communications network and a quality of service level of the concurrent communications network;
saving the determined quality of service levels of all measured communications networks;
determining if a vertical handover is needed based on the measured quality of service level information; and
executing the vertical handover.

Another aspect of the invention is to provide an apparatus comprising:
a receiver comprising means for receiving messages from at least two different communications networks;
a display unit;
a processor; and
a memory including a computer program code, where
the memory and the computer program code configured to, with the processor, cause the apparatus at least to:
   determine simultaneously at least one parameter of a quality of service level of at least two concurrent communications networks;
   determine if the quality of service level of the serving network is adequate to an end-user application, and if it is not adequate;
   determine which one of the concurrent communications networks is the most suitable serving network; and
   making a vertical handover to the most suitable serving network.

Another aspect of the invention is to provide a home agent residing in an information processing apparatus of an access network, which home agent comprises also a multi-interface manager comprising means for selecting a communications network to be utilized between a serving backbone network (1) and a mobile node (6).

Another aspect of the invention is to provide a computer readable storage medium having computer-executable components comprising:
computer readable code for measuring at least one parameter of a quality of service (QoS) of a serving communications network in a mobile apparatus during a connection;
computer readable code for determining if the measured quality of service level is above a threshold;
computer readable code for determining if a quality of service level of at least one concurrent communications network is needed,
computer readable code for measuring in real-time simultaneously both a quality of service level of the serving communications network and a quality of service level of the concurrent communications network;
computer readable code for saving the determined quality of service levels of all measured communications networks;
computer readable code for determining if a vertical handover is needed based on the measured quality of service level information; and
computer readable code for executing the vertical handover.

A technical effect of the invention is that both the QoS level of the utilized communications connection and of all available alternative communications connections are known on real-time bases in a mobile client. If the serving communications connection degrades below an acceptable level, then the mobile management system can start a vertical handover procedure to another communications network smoothly and seamlessly.

Another technical effect of the invention is that the end-user all the time has knowledge about the QoS levels of alternative communications networks. Therefore, the end-user is able to select a new more suitable serving communications network if a need arises. The end-user can select all the time a communications network that suits best the end-user application at that time and place. The end-user is able also to optimize communication costs if there are available free or cheap communications networks.

Another technical effect of the invention is that the end-user can determine in what situation the inventive method is utilized. For example the QoS measurements of the other communications networks are advantageously started only in a case where the serving communications network has degraded under some predetermined QoS level. When a new communications network, having better QoS level is found, a vertical handover can advantageously be accomplished right away without any disturbing blackouts in the ongoing connection.

Another technical effect of the invention is that a vertical handover can be accomplished any time without disturbing blackouts which may be the case when a prior art mobility management procedure is utilized. This is possible because in the method according the invention the mobile client may advantageously receive during measurement periods one and the same transmission via several downlinks of different communications networks. Therefore, if the need for a vertical handover to another communications network arises the mobile client can make the vertical handover to a communications network whereto during measurement period the downlink transmission already has been duplicated.

A further technical effect of the invention is that utilizing the inventive method the mobile end-users load the available communications networks more uniform. If some communications network suffers high load problems the mobile client according to the invention makes a vertical handover to another communications network which is not so highly loaded. So the use of the invention equalizes loads of available competing communications networks. This means that a particular service provider needs not to invest to extra capacity which is only needed in some short high demand periods.

Some further technical effects of the invention are disclosed in the dependent claims.

The idea of the invention is basically as follows: A wireless communication terminal comprises a functionality which can measure a QoS level, at least every now and then, of all available communications networks. The QoS information may comprise usable bandwidth, signal strength, error ratio, transfer delay, latency time and jitter, for example. Some examples of possible communications networks where the invention may be used are Ethernet, Wi-Fi®, 3G and WiMAX.

The QoS level of the currently serving communications network is measured continuously “passively” during transmissions from the core network side to the wireless terminal. The required QoS level is advantageously rated on the bases of the end-user application. The functionality according to the invention comprises also means by which the wireless terminal can send, for example to a home agent residing in the core network of the serving communications network, a request to activate also a downlink transmission via at least one other communications network whereto the wireless terminal can be connected. The required transmission according to the invention may be a duplicate of the transmission of the serving communications network or an artificial test transmission. Also it is possible that the inventive functionality of the wireless terminal instructs the core network side to alternate the transmission between all possible communications networks. In that case only one communications network has an active downlink at a time to the wireless terminal.

The functionality according to the invention measures the service quality of each accessible communications network during these downlink transmissions. The measurement may be “passive”, i.e. continuous QoS measurements of the serving network, if the QoS level of the serving network is acceptable. “Active” QoS measurements are only done if the inventive functionality of the wireless terminal so requests. The request may comprise that “active” measurement period is a single measurement event or that the measurement period is periodically repeated during some time period determined by the functionality according to the invention.

At least the last QoS measurement result of all measured communications networks is advantageously saved in a memory unit of the wireless terminal. The functionality according to the invention uses these saved QoS measurement results for determining if a vertical handover is needed. In determining a possible vertical handover the measured QoS results are advantageously compared to the requirements of the end-user application. The latest QoS results are also utilized to determine, which one of all possible communications networks available should be preferred when the vertical handover is actually accomplished. By using the inventive method it is possible to activate and manage vertical handovers on the grounds of the end-user application without any blackouts and other disturbances.

Further scope of applicability of the present invention will become apparent from the detailed description given hereafter. However, it should be understood that the detailed description and specific examples, while indicating advantageous embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and accompanying drawings which are given by way of illustration only, and thus are not limitative of the present invention and wherein

FIG. 1 shows a schematic representation of a network where the invention is utilized;

FIG. 2 shows as an exemplary block diagram main functional blocks of the invention;

FIG. 3 shows as an exemplary a flow chart including main functional steps of the method according to the invention; and

FIG. 4 shows the main parts of the terminal device according to the invention by way of example.

### DETAILED DESCRIPTION OF THE DRAWINGS

In the following description, considered embodiments are merely exemplary, and one skilled in the art may find other ways to implement the invention. Although the specification may refer to “an”, “one; or “some” embodiment(s) in several locations, this does not necessarily mean that each such reference is made to the same embodiment(s), or that the feature only applies to a single embodiment or all embodiments. Single features of different embodiments may also be combined to provide other embodiments.

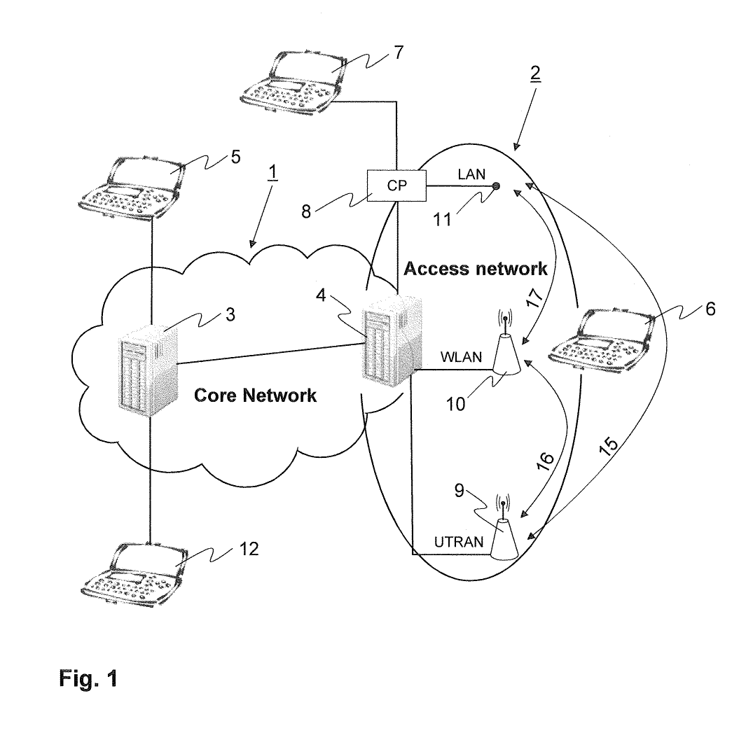

In FIG. 1 there is depicted an exemplary network configuration of two concatenated communications networks 1 and 2 where the method of vertical handover according to the invention can advantageously be implemented. The exemplary network configuration of FIG. 1 utilizes in mobility management MIP protocol (Mobile IP). The MIP protocol provides a handover execution and it also provides information about available network interfaces, home agent addresses and link qualities. However, the inventive vertical handover method is not limited to be used only with MIP protocol but also other mobility management protocols may be utilized. Some other possible mobility protocols are mSCTP, SCTP (Stream Control Transmission Protocol), HIP and SIP (Session Initiation Protocol).

The exemplary network configuration comprises a backbone network 1 that may be any digital communications network. It may be for example Internet. A local access network 2 is connected to the backbone network 1 via an edge router 4 that resides at an edge of the backbone network 1. The edge router 4 is connected to a core router 3 inside the backbone network 1.

Via the core router 3 also two exemplary terminals 5 and 12 are connected to the backbone network 1. The depicted terminals may be for example cellular phones, smart phones, PDAs, Laptops or video gaming apparatuses that can establish a connection to the Internet. The terminals 5 and 12 may be capable of establishing a connection to the core router 3 by either a wired connection or a wireless connection.

Some examples of possible local access networks 2 where the invention may be used are Ethernet, Wi-Fi®, 3G and WiMAX.

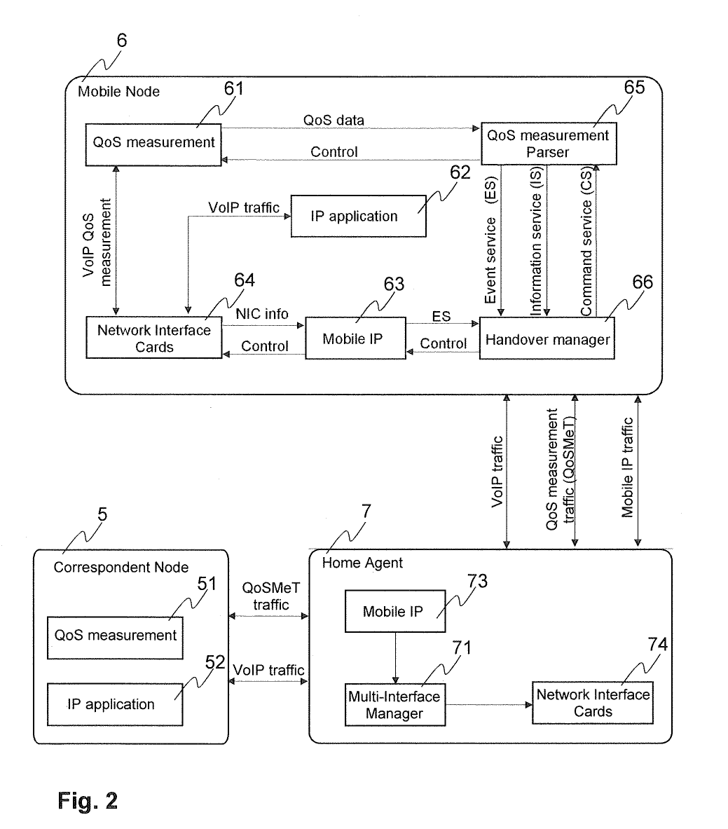

In the exemplary access network 2 in FIG. 2 a cross connection point (CP) 8, a home agent 7, a LAN access point 11, a WLAN access point 10 and an UTRAN access point 9 (UMTS Terrestrial Radio Access Network) have each a connection to the edge router 4 residing in the backbone network 1. An exemplary information-processing device 6 may be able to establish a connection to all three depicted access points. Therefore, it can be in connection to a wired LAN, to a WLAn or cellular phone network. The exemplary information-processing device 6 may be a laptop computer, smart phone, PDA or video game console, for example.

The information-processing device 6 can utilize the method according to the invention by which a smooth vertical handover may be accomplished between available access communications networks, references 15, 16 and 17. The information-processing device 6 comprises a software application which can measure QoS level of the whole communications link through the backbone network 1 and access network 2, i.e. for example between the terminal 5, which may be called a correspond node, and the information processing device 6, which may be called a mobile node. QoS level may comprise one or more parameters depicting how well the utilized transmission channel can fulfil the requirements of the end-user application. The QoS level information may comprise as parameters a usable bandwidth, signal strength, error ratio, transfer delay, latency time and jitter, for example.

The software application according to the invention comprises several functional blocks whereby QoS level of a utilized communications link can be measured, parsed and after that a proper communications network for vertical handover can be selected. Advantageously, parsed QoS levels of all measured communications networks are saved in a memory unit included in the information-processing device 6.

The software application according to the invention comprises also a functional block that can use parsed QoS level data for estimating whether the QoS level of the serving communications network at that time is not good enough for the end-user application that is running in the information-processing device 6. The end-user application may be a VoIP connection (Voice over IP), for example. The depicted functional block can decide that QoS measurements of other available communications networks should be done. For accomplishing this task, the functional block of the software application sends a measurement command to a home agent 7 residing in the backbone network of the serving communications network.

In the network arrangement according to the invention all transmissions to and from the mobile node 6 is tunnelled via the home agent 7. The home agent 7 comprises advantageously means whereby it can convey a VoIP connection towards the information-processing device 6 also through another communications network than that which is currently utilized in the ongoing VoIP connection. The home agent 7 may for example duplicate the ongoing VoIP transmission to at least one other communications network. Alternatively, the home agent may alternate the current transmission between feasible communications networks. In both cases, the information-processing device 6 measures QoS level of the VoIP connection. By doing so, the information-processing device 6 is capable of deciding which one of all available communications networks should be preferred for the end-user application.

The home agent 7 may also direct to the other access networks traffic which is artificial. In FIG. 1 the exemplary device 12 may be a test message generator whose messages can advantageously be utilized in QoS measurements.

The time interval between QoS measurement session may vary. If the serving communications network can offer QoS level which is satisfactory, then in that case the QoS measurements of other communications networks can be accomplished more sparsely. However, if there are fluctuations in the QoS level of the serving communications network, the QoS measurements of the other communications networks are accomplished more often. The vertical handover method according to the invention can adapt itself to the changing QoS environment.

In one embodiment, the measurement of concurrent communications networks for accomplishing a vertical handover is accomplished only when the QoS level of the serving network is below a predetermined threshold level. When the results of the QoS measurements are at hand it is possible to accomplish a vertical handover if the QoS level of the serving communications network is not sufficient.

In one other embodiment, the QoS levels of all concurrent communications networks are updated regularly. In that embodiment, it is possible to select always the communications network that can offer best available QoS level to the end-user application.

Some exemplary system components and their physical locations in a mobile node 6, home agent 7 and correspondent node 5 are depicted in FIG. 2.

For accomplishing the method steps according to the invention the exemplary mobile node 6 advantageously comprises a QoS measurement block 61, a QoS measurement parser block 65, a handover manager block 66, a Mobile IP block 63, an end-user application 62 and at least two network interface cards 64.

An end-user interface is available through hand over manager 66 and QoS measurement parser 65. The handover manager user interface provides information about available network interfaces 64 and it enables configuration of parameters for handover. The QoS measurement parser 65 initiates measurement events. A user interface of the QoS measurement parser is advantageously able to display available QoS information received from the QoS measurement block 61.

The handover manager 66 sends control commands which are needed for accomplishing the required QoS measurements and actual vertical handover. The handover manager 66 sends measurement and parsing commands (CS) to the QoS measurement parser 65. The QoS measurement parser 65 informs the QoS measurement block 61 via a control line which QoS parameters should be measured, which communications networks should be measured and when each of them should be done.

The QoS measurement block 61 has a connection to all network interface cards 64 of the mobile node 6. Therefore, QoS measurement block 61 is able to measure quality metrics of the traffic regardless of the utilized communications network. The QoS measurement block 61 provides real-time QoS measurement information and it also performs PSQA measurements (Pseudo-subjective Quality Assessment). After accomplishing one QoS measurement the QoS measurement block 61 transmits the measured QoS data to the QoS measurement parser 65.

After parsing the QoS data the QoS measurement parser 65 informs the handover manager 66 via two lines about events (ES) and measurement information (IS).

The handover manager 66 comprises also means whereby the end-user can define vertical handover parameters. The handover manager 66 compares QoS measurement information with the set vertical handover parameters. If a condition for a vertical handover is fulfilled the handover manager 66 sends a handover command to the Mobile IP application 63 via a control line.

The Mobile IP application 63 for it's part changes the VoIP communication from utilized network interface card 64 to another network interface card (not depicted in FIG. 2). After that network interface info (NIC) is transmitted to the Mobile IP application 63. Optionally the NIC info is transmitted (ES) also from the Mobile IP application 63 to the handover manager 66.

The end-user application 62, for example VoIP, is thereby changed from one serving communications network to another communications network. One example is a vertical handover of a VoIP connection from a 3G network to a Wi-Fi®. The VoIP traffic is not disturbed during the depicted vertical handover when the method according to the invention is utilized.

The home agent 7, residing in the core network of the serving communications network, comprises also a Mobile IP application 73, network interface cards 74 and a multi-interface manager 71. The multi-interface manager 71 in the home agent 7 takes care of packet redirection.

The multi-interface manager 71 is able to send a duplicate or sequential packets from home agent 7 to different network interfaces 74 which are available. Therefore, the Mobile IP application 73 is advantageously configured in a way so that all packets from core network 1 to the mobile node 6 are at all times tunneled through the home agent 7.

The multi-interface manager 71 of the home agent 7 comprises means for duplicating transmission data, i.e. same transmission is concurrently conveyed via two different communications networks to the mobile node 6. Alternatively, the multi-interface manager 71 advantageously alternates the transmission between at least two communications networks during a QoS measurement phase.

The mobile node 6 and home agent 7 change actual VoIP traffic, QoS measurement data from and to the core network and Mobile IP traffic which is needed in the mobility management of the mobile node 6.

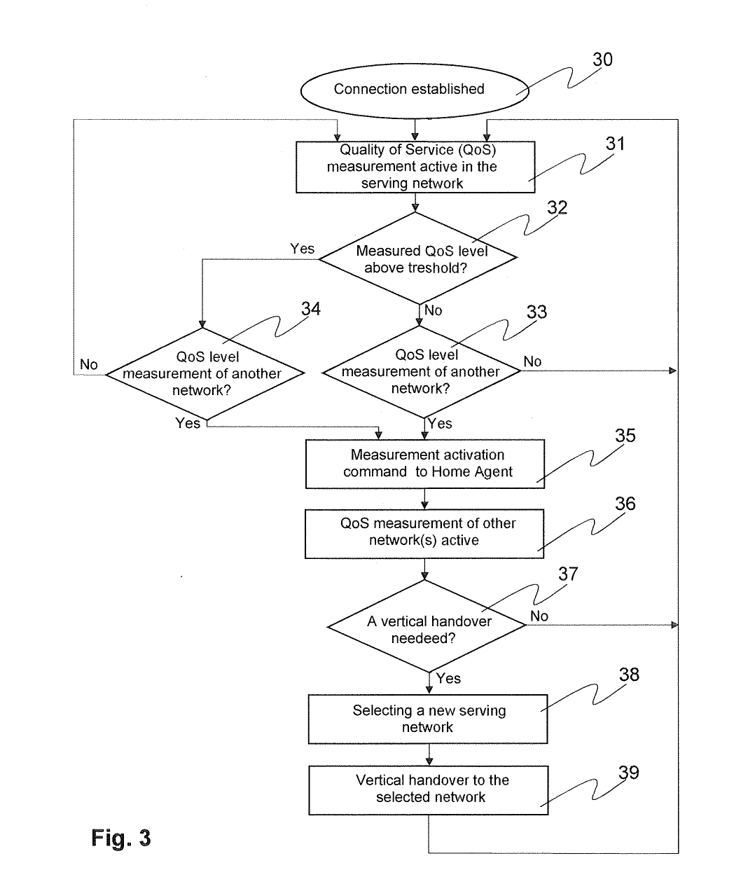

The main steps of the method according to the invention are shown as an exemplary flow chart in FIG. 3.

The connection between two information terminals is established in step 30. The connection may be a VoIP connection between mobile node 6 and correspondence node 5 in FIG. 1. The utilized access network comprises at least two different communications networks. In step 30 one of the communications networks is selected as a serving network.

In step 32 QoS measurements are accomplished as background processing in the mobile node 6. In step 32 the QoS measurement result is compared against at least one QoS threshold. The QoS threshold may be defined by an end-user. Alternatively it may be a predefined application-specific or communications network-specific threshold. The utilized QoS threshold may be selected automatically from a group of predefined thresholds when a traffic detector or application detector is in use in the mobile node 6. As an example of a possible QoS threshold utilized in pseudo-subjective quality assessment (PSQA) may be a numerical value 2.5.

If the comparison gives as a result that the QoS level is high enough then the process moves to step 34. In step 34 is decided if a QoS level of at least one concurrent communications network should be measured or not. If the conclusion is that additional QoS measurements are not needed the process returns to step 31 and a new QoS measurement in the serving communications network connection takes place.

If in step 34 it is decided that also at least one other communications network should be measured, the process is guided to step 35. In step 35 a command to activate concurrent VoIP channel towards the mobile node 6 is sent to the home agent 7.

If the comparison in step 32 gives as a result that the QoS level is not high enough then the process moves to step 33. In step 33 it is decided if a QoS level of at least one concurrent communications network should be measured. If the outcome of the decision is that there is no need to measure a QoS level of a concurrent communications network then the process returns to step 31.

If the outcome of the decision making in step 33 is that at least one other communications network should be measured and analyzed the process continues to step 35. In step 35 a command to activate concurrent VoIP channel towards the mobile node 6 is sent to the home agent 7.

In step 36 the mobile node 6 receives for example VoIP transmission via an alternative communications network. The mobile node 6 makes QoS measurements and advantageously saves them in a memory belonging to the hardware of the mobile node 6.

In step 37 it is decided if a vertical handover is needed or not. If there is no need to make a vertical handover, the process returns to step 31 and a new QoS measurement in the serving communications network connection takes place.

If in step 37 it is decided that there is a need to make a vertical handover, the process continues to step 38. In step 38 a new serving communications network is selected. The selection criterion may be how well the new serving communications network can support the end-user application which is currently executed in the mobile node 6.

When the network selection is accomplished then in step 39 the vertical handover is immediately made to the new serving communications network. After the accomplished vertical handover the process returns to step 31 and a new QoS measurement in the selected new serving communications network takes place.

Any of the steps described or illustrated in FIG. 3 may be implemented using executable instructions in a general-purpose or special-purpose processor and stored on a computer-readable storage medium (e.g., disk, memory, or the like) to be executed by such a processor. References to ‘computer-readable storage medium’ and ‘computer’ should be understood to encompass specialized circuits such as field-programmable gate arrays, application-specific integrated circuits (ASICs), USB flash drives, signal processing devices, and other devices.

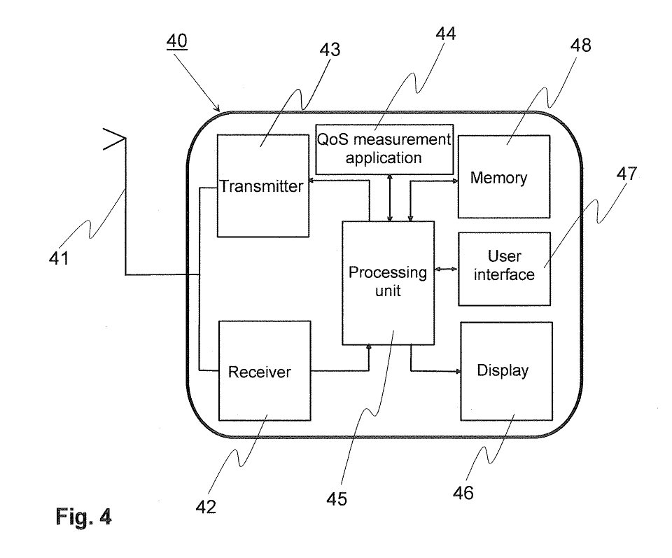

FIG. 4 shows, by way of example, the functional main parts of a wireless apparatus 40. The wireless apparatus 40 may be, for example, a prior art GSM, GPRS or UMTS terminal device, Laptop, smart phone, PDA or a game consol.

The wireless exemplary apparatus 40 in FIG. 4, for example a mobile node 6 in FIG. 1, utilizes some advantageous features of the invention. The depicted wireless apparatus 40 uses an antenna 41 in reception of signals from an access point of a serving communications network.

The wireless apparatus 40 comprises a radio RF receiver 42 (Radio Frequency). The RF receiver 42 comprises some known prior art receiver means for all messages or signals to be received from a plurality of communications networks.

The wireless apparatus 40 comprises also an RF transmitter 43. The RF transmitter may be utilized for sending messages to the access point of the serving communications network.

The wireless apparatus 40 advantageously comprises also a user interface 47. Via the user interface 47 the end-user of the apparatus 40 can give commands to the apparatus 40. An example of possible commands is an end-user activated vertical handover.

The wireless apparatus 40 comprises advantageously a display unit 46 for showing QoS results during or after the QoS measurement process. The display unit 46 may be for example an LCD display, OLED display or LED display. However, a man skilled in the art may utilize also other known display types.

The display unit 46 of the wireless apparatus 40 is capable of showing all detected QoS measurement results. The display unit 46 may also comprise a means for showing a current reading of QoS measurement during or after the measurement process.

The exemplary wireless apparatus 40 comprises advantageously a QoS measurement application 44. The QoS measurement application 44 advantageously comprises QoS measurement parser (reference 65 in FIG. 2) and handover manager (reference 66 in FIG. 2). The software application may be implemented in C++, Windows or Linux for example.

A processor unit 45 controls the wireless apparatus 40. The processor unit 45 may be implemented by a processor, which may comprise but is not limited to one microprocessor. It may also comprise at least one processor with an accompanying digital signal processor or one or more special-purpose computer chips, one or more field-programmable gate arrays (FPGA), one or more controllers and one or more application-specific integrated circuits (ASICS).

The wireless apparatus 40 may also comprise advantageously one or more internal and/or external memories 48 (e.g., ROM, RAM, FLASH, USB, CD-ROM, etc.). The memory 48 is advantageously capable of saving computer program code which is utilized in QoS measurement and vertical handover process.

The processor unit 45 advantageously accomplishes process steps of QoS measurement and vertical handover by executing proper computer program code instructions according to the embodiments of the invention. In said execution of the Qos measuring and vertical handover process the processor unit 45 utilizes advantageously computer program code instructions saved in the memory 48.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for executing a vertical handover, the method comprising:
measuring at least one parameter of a quality of service (QoS) of a serving communications network (9, 10, 11) in a mobile apparatus during a communications connection (31);
determining if the measured quality of service parameter is above a threshold (32); and
determining if a quality of service level measurement of at least one concurrent communications network (9, 10, 11) is needed (33),
characterized in that the method further comprises
measuring in real-time simultaneously a quality of service level of the serving communications network and a quality of service level of the concurrent communications network (35, 36);
saving the determined quality of service levels of all measured communications networks;
determining if a vertical handover is needed based on the measured quality of service level information (38); and
executing the vertical handover (39).

2. The method according to claim 1, characterized in that for the simultaneous quality of service measurements a home agent (7), residing in an access network (2), duplicates data transferred in the serving communications network and conveys the duplicated data simultaneously to at least one other communications network (9, 10, 11).

3. The method according to claim 1, characterized in that for the simultaneous quality of service measurements a home agent (7), residing in an access network (2) alternates the transmission between the serving communications network and at least one other communications network (9, 10, 11).

4. The method according to claim 1, characterized in that a decision to activate measurement of the level of quality of service of concurrent communications networks (9, 10, 11) is made in one of the following ways: by an end-user command, periodically or due to the fact that a quality of service threshold is not satisfied (33).

5. The method according to claim 1, characterized in that in the method a need for the vertical handover is determined on at least one of the following quality parameters: a usable bandwidth, signal strength, error ratio, transfer delay, latency time or jitter.

6. An apparatus (6, 40) comprising:
a receiver (42) comprising means for receiving messages from at least two different communications networks (9, 10, 11);
a display unit (46);
a processor (45); and
a memory (48) including a computer program code,
characterized in that:
the memory and the computer program code configured to, with the processor, cause the apparatus (6, 40) at least to:
determine simultaneously at least one parameter of a quality of service level of at least two concurrent communications networks (9, 10, 11);
determine if the quality of service level of a serving network is adequate to an end-user application, and if it is not adequate;
determine which one of the concurrent communications networks is the most suitable serving network; and
making a vertical handover to the most suitable serving network.

7. The apparatus according to claim 6, characterized in that the memory and the computer program code configured to, with the processor, cause the apparatus (6, 40) to send a request to a home agent (7), residing in an access network (2), to guide at least part of the ongoing downlink transmission via at least two different communications networks (9, 10, 11).

8. The apparatus according to claim 6, characterized in that the memory and the computer program code configured to, with the processor, cause the apparatus (6, 40) to instruct a mobility management application (63) to make the vertical handover.

9. The apparatus according to claim 6, characterized in that it is one of the following: a GSM, GPRS or UMTS terminal device, Laptop, smart phone, PDA or a game consol.

10. A home agent (7) residing in an information processing apparatus of an access network (2), characterized in that the home agent (7) comprises also a multi-interface manager (71) comprising means for selecting a communications network (9, 10, 11) to be utilized between a serving backbone network (1) and a mobile node (6).

11. The home agent according to claim 10, characterized in that the home agent (7) is, by utilizing a memory and the computer program code, configured to, with the processor of the information processing apparatus, cause the information processing apparatus to guide at least part of the ongoing downlink transmission via at least two different concurrent communications networks (9, 10, 11) to the mobile node (6).

12. A computer readable storage medium having computer-executable components comprising:
computer readable code for measuring at least one parameter of a quality of service (QoS) of a serving communications network in a mobile apparatus during a connection;
computer readable code for determining if the measured quality of service level is above a threshold; and
computer readable code for determining if a quality of service level of at least one concurrent communications network is needed,
characterized in that the computer readable storage medium further comprises:
computer readable code for measuring in real-time simultaneously both a quality of service level of the serving communications network and quality of service levels of concurrent communications networks;
computer readable code for saving the determined quality of service levels of all measured communications networks;
computer readable code for determining if a vertical handover is needed based on the measured quality of service level information; and
computer readable code for executing the vertical handover.
